(19) United States
(12) Patent Application Publication
(10) Pub. No.: US 2007/0101592 A1
(43) Pub. Date: May 10, 2007

(54) Pivotable handsaw assembly

(75) Inventor: Peter (Hao) Wen, Shanghai (CN)

Correspondence Address: EDMONDS, P.C., 16815 ROYAL CREST DRIVE, SUITE 130, HOUSTON, TX, 77058, US

(73) Assignee: KRAFTOOL MFG. (SHANGHAI) CO., LTD., SHANGHAI (CN)

(21) Appl. No.: 11/582,828

(22) Filed: Oct. 18, 2006

(30) Foreign Application Priority Data
Oct. 20, 2005 (CN) 200510030681.7

(51) Int. Cl. B23D 51/01

(52) U.S. Cl. 30/517

(57) ABSTRACT

A pivotable handsaw assembly in which the saw blade can pivot and be used to saw wood or other materials is provided. The pivotable handsaw assembly can be easy to use and the angle of the saw blade may be changed easily. The advantages of this pivotable handsaw assembly include its stability and the ease of replacing the saw blade when cutting to a fixed cutting depth.

### CROSS REFERENCE TO RELATED APPLICATION

This application claims the benefit under 35 U.S.C. §119 of Chinese Patent Application having Ser. No. 200510030681.7, filed on Oct. 20, 2005, which is incorporated by reference herein.

### BACKGROUND OF THE INVENTION

1. Field of the Invention

Embodiments of the present invention generally relate to a handsaw assembly. More particularly, embodiments of the present invention relate to a handsaw assembly that can pivot.

2. Description of the Related Art

A conventional handsaw has a saw blade and handle. The saw blade has at least one tongue. One side of the handle is slotted. The tongue and the slot correspond to fix the sawblade to the handle. An example of such a handsaw is disclosed in German Patent No. 2931426 (1982). Such construction provides an instable handsaw, and also creates difficulty when cutting to a fixed cutting depth. Such construction also makes replacing the saw blade difficult.

There is a need, therefore, for a handsaw assembly that is more stable, easily replaceable, and can more easily cut at greater depths.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic breakaway of an illustrative handsaw assembly in accordance with one or more embodiments described.

FIG. 2 depicts a side plan view of an illustrative handsaw assembly in accordance with one or more embodiments described.

FIG. 3 depicts a partial cross section view of the handsaw assembly shown in FIG. 2 along lines A-A.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

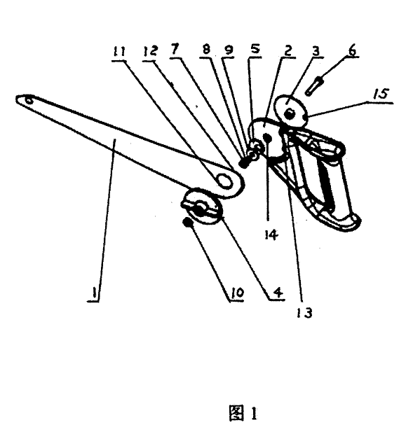

A pivotable handsaw assembly that can be easily used and allows the angle of the saw blade to be changed easily is provided. FIG. 1 depicts a schematic breakaway of an illustrative handsaw assembly in accordance with one or more embodiments described. According to one or more embodiments, the handsaw assembly is pivotable and includes a saw blade 1, user handle 2, pivotable member 3, grip member 4, and eccentric wheel 5. The pivotable member 3 can be arranged adjacent a first side of the user handle 2 and the grip member 4 can be arranged adjacent a second side of the user handle 2.

The pivotable member 3, user handle 2, grip member 4, and saw blade 1 each include a bore or opening 11, 14 formed therethrough. As such, those components can be connected by one or more fastener members including one or more screws, bolts and nuts. For example, a bolt 6 can be used to fasten the pivotable member 3, user handle 2, grip member 4, and saw blade 1 together. A nut 10 can be used to cap the bolt 6 and hold the components in place.

In one or more embodiments, the saw blade 1 can be pivoted relative to the user handle 2. The saw blade 1 and the user handle 2 can pivot about the bolt 6 and the eccentric wheel 5. The pivotable member 3 can include two or more projections 15 formed thereon The projections 15 on the pivotable member 3 can limit the range or distance the user handle 2 can move about the wheel 5.

In operation, the pivotable member 3 can rotate through a certain arc so that the eccentric wheel 5 can rotate through a certain angle to move the saw blade 1 away from the slot 13 on the user handle 2 to rotate. Accordingly, the pivotable handsaw assembly is easy to use and the angle of the saw blade 1 can be easily changed.

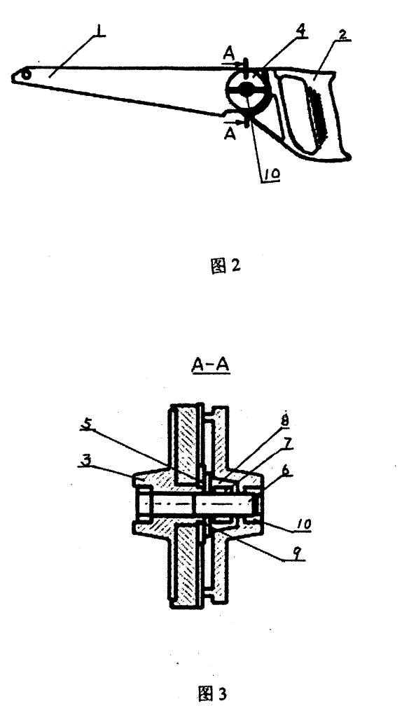

FIG. 2 depicts a side plan view of an illustrative handsaw assembly in accordance with one or more embodiments described. Referring to FIGS. 1 and 2, the hole 11 for the bolt 6 is located at a first end of the saw blade 1. The end of the saw blade 1 is preferably a round projection 12 that can fit or be disposed within the slot 13. Through-hole 14 for bolt 6 can be formed at one end of the user handle 2. Slot 13 can be used for connecting saw blade 1 and user handle 2 inside through-hole 14. Two projections 15 can be formed on inner surface of pivotable member 3. Pivotable handle 3 can be installed outside the user handle 2. The grip member 4 can be installed outside saw blade 1. Pivotable handle 3, user handle 2, grip member 4, and saw blade 1 can be connected via bolt 6 and nut 10. Bolt 6 can be inserted through pivotable member 3, grip member 4, and eccentric wheel 5. The hexagonal head of bolt 6 can be fitted and fixed in the corresponding hexagonal hole of handle 3. Nut 7 can press against eccentric wheel 5 via washers 8, 9 and form a mechanism that can pivot saw blade 1 a certain distance along with the projections on pivotable member 3. Bolt 6 can pass through eccentric wheel 5, which can be installed between saw blade 1 and user handle 2 via nut 7, washers 8, 9.

FIG. 3 depicts a partial cross section view of the handsaw assembly shown in FIG. 2 along lines A-A. As shown in FIG. 3, the movement of saw blade 1 can be realized through the eccentric wheel 5 and through-hole 14. If pivotable member 3 pivots a certain distance, the two projections 15 on pivotable member 3 can limit the pivoting of the user handle 2. The user handle 2 can only rotate through a certain arc. As a result, eccentric wheel 5 can pivot through a certain angle to move saw blade 1 away from the slot 13 on the user handle 2.

In operation, an operator can turn the nut 10 on grip member 4 to loosen bolt 6 and then pivot grip member 4 from a “locked” position to a “unlocked” position. As a result, the eccentric wheel 5 can move through a certain angle. Hole 11 in saw blade 1 can be fixed to eccentric wheel 5. In this way, end part 12 on saw blade 1 can move away from the slot 13 on the user handle 2. After the saw blade 1 can be pivoted to an appropriate position, grip member 4 can be pivoted from the “unlocked” position to the “locked” position.

In one or more embodiments, the saw blade 1 can be fixed to the handle 2. The handsaw can then be used after the nut 10 on the grip member 4 is fastened.

In another embodiment, the invention relates to:
1. A pivotable handsaw including a saw blade 1 and a handle 2, characterized by the following facts: a pivotable member 3 is arranged outside the handle 2, and a grip member 4 is arranged outside the saw blade 1; pivotable member 3, handle 2, grip member 4, and saw blade 1 are connected by bolt 6 and nut 10; an eccentric wheel 5 is mounted between saw blade 1 and handle 2 with the aid of bolt 6, nut 7 and washers 8, 9.
2. The pivotable handsaw assembly described in paragraph 1 characterized by the fact that a hole 11 for bolt 6 can be formed at one end of said saw blade 1, and the end part is a round projection 12.
3. The pivotable handsaw described in paragraphs 1 or 2 characterized by the fact that through-hole 14 for bolt 6 is formed at one end of handle 2; slot 13 used for connecting saw blade 1 and handle 2 is formed inside through-hole 14.
4. The pivotable handsaw described in any of paragraphs 1, 2, or 3 characterized by the fact that two projections 15 are formed on the edge of said pivotable member 3.
5. A handsaw comprising:

a saw blade;

a handle;

a pivotable member; and

a grip member,

wherein the pivotable member is arranged outside the handle, and the grip member is arranged outside the saw blade.
6. The handsaw of paragraph 5, wherein the (1); pivotable member (3), handle (2), grip member (4), and saw blade (1) are connected by bolt (6) and nut (10);
7. The handsaw of paragraphs 5 or 6; wherein an eccentric wheel (5) is mounted between saw blade (1) and handle (2) with the aid of bolt (6), nut (7) and washers (8, 9).
8. The handsaw of any of paragraphs 5 to 7, wherein a hole (11) for bolt (6) is formed at one end of said saw blade (1), and the end part is a round projection (12).
9. The handsaw of any of paragraphs 5 to 8, wherein through-hole (14) for bolt (6) is formed at one end of handle (2); and slot (13) used for connecting saw blade (1) and handle (2) is formed inside through-hole (14).
10. The handsaw of any of paragraphs 5 to 9, wherein two projections (15) are formed on the edge of said pivotable member (3).

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A handsaw comprising:
a saw blade;
a handle;
a pivotable member; and
a grip member,
wherein the pivotable member is arranged outside the handle, and the grip member is arranged outside the saw blade.

2. The handsaw of claim 1, wherein the (1); pivotable member (3), handle (2), grip member (4), and saw blade (1) are connected by bolt (6) and nut (10);

3. The handsaw of claim 2; wherein an eccentric wheel (5) is mounted between saw blade (1) and handle (2) with the aid of bolt (6), nut (7) and washers (8, 9).

4. The handsaw of claim 3, wherein a hole (11) for bolt (6) is formed at one end of said saw blade (1), and the end part is a round projection (12).

5. The handsaw of claim 4, wherein through-hole (14) for bolt (6) is formed at one end of handle (2); and slot (13) used for connecting saw blade (1) and handle (2) is formed inside through-hole (14).

6. The handsaw of claim 2, wherein two projections (15) are formed on the edge of said pivotable member (3).
